(19) United States
(12) Patent Application Publication
(10) Pub. No.: US 2025/0365556 A1
(43) Pub. Date: Nov. 27, 2025

(54) GROUP POSITIONING IN TELECOMMUNICATION SYSTEMS

(71) Applicant: Nokia Technologies Oy, Espoo (FI)

(72) Inventors: Diomidis MICHALOPOULOS, Munich (DE); Taylan SAHIN, Munich (DE)

(21) Appl. No.: 18/874,781

(22) PCT Filed: Apr. 27, 2023
(86) PCT No.: PCT/EP2023/061127

§ 371 Date: Dec. 13, 2024

(30) Foreign Application Priority Data
Jun. 14, 2022 (FI) 20225528

(51) Int. Cl. H04W 4/02; H04W 64/00

(52) U.S. Cl. CPC H04W 4/025; H04W 64/00

(57) ABSTRACT

According to an example aspect of the present invention, there is provided an apparatus configured to store, in a first user equipment, information defining a group of user equipments, the first user equipment being comprised in the group, and associate at least one positioning reference unit with the user equipments of the group such that each user equipment of the group is associated with at least one positioning reference unit, or receive from a cellular communication network the associations of the user equipments of the group with the at least one positioning reference unit.

### FIELD

The present disclosure relates to positioning of mobile nodes in a wireless communication network.

### BACKGROUND

Positioning of a user equipment, UE, in a cellular network involves deriving an estimate for the current location of the user equipment. Various mechanisms are in use in cellular networks, NWs, to derive the estimate for the current location. For example, the estimate may be derived from time difference of arrival information, and/or it may be assisted with detectable short-range networks, such as wireless local area network, WLAN, hot spots.

### SUMMARY

According to some aspects, there is provided the subject-matter of the independent claims. Some example embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to store, in a first user equipment, information defining a group of user equipments, the first user equipment being comprised in the group, and associate at least one positioning reference unit with the user equipments of the group such that each user equipment of the group is associated with at least one positioning reference unit, or receive from a cellular communication network the associations of the user equipments of the group with the at least one positioning reference unit.

According to a second aspect of the present disclosure, there is provided an apparatus comprising at least one processing core, at least one memory including computer program code, the at least one memory and the computer program code being configured to, with the at least one processing core, cause the apparatus at least to store, in a cellular core network node, information defining a group of user equipments, a first user equipment being comprised in the group, store information associating at least one positioning reference unit with the user equipments of the group such that each user equipment of the group is associated with at least one positioning reference unit, and determine a location of at least one user equipment in the group based on information concerning at least one of the positioning reference units associated with the user equipments in the group.

According to a third aspect of the present disclosure, there is provided an apparatus comprising at least one processing core, at least one memory including computer program code, the at least one memory and the computer program code being configured to, with the at least one processing core, cause the apparatus at least to control at least one cellular cell as a base station, receive a list of user equipments comprised in a group, not all of the user equipments in the group being in the at least one cellular cell controlled by the base station, and generate, and provide to at least one user equipment of the group, a time-multiplexed uplink sounding reference signal and/or sidelink positioning reference signal transmission schedule for the user equipments in the group, or receive the time-multiplexed uplink sounding reference signal and/or sidelink positioning reference signal transmission schedule for the user equipments in the group from a first user equipment from among the user equipments in the group.

According to a fourth aspect of the present disclosure, there is provided a method comprising storing, in a first user equipment, information defining a group of user equipments, the first user equipment being comprised in the group, and associating at least one positioning reference unit with the user equipments of the group such that each user equipment of the group is associated with at least one positioning reference unit, or receive from a cellular communication network the associations of the user equipments of the group with the at least one positioning reference unit.

According to a fifth aspect of the present disclosure, there is provided a method comprising storing, in a cellular core network node, information defining a group of user equipments, a first user equipment being comprised in the group, storing information associating at least one positioning reference unit with the user equipments of the group such that each user equipment of the group is associated with one positioning reference unit, and determining a location of at least one user equipment in the group based on information concerning at least one of the positioning reference units associated with the user equipments in the group.

According to a sixth aspect of the present disclosure, there is provided a method, comprising controlling at least one cellular cell as a base station, receiving a list of user equipments comprised in a group, not all of the user equipments in the group being in the at least one cellular cell controlled by the base station, and generating, and providing to at least one user equipment of the group, a time-multiplexed uplink sounding reference signal and/or sidelink positioning reference signal transmission schedule for the user equipments in the group, or receiving the time-multiplexed uplink sounding reference signal and/or sidelink positioning reference signal transmission schedule for the user equipments in the group from a first user equipment from among the user equipments in the group.

According to a seventh aspect of the present disclosure, there is provided an apparatus comprising means for storing, in a first user equipment, information defining a group of user equipments, the first user equipment being comprised in the group, and associating at least one positioning reference unit with the user equipments of the group such that each user equipment of the group is associated with at least one positioning reference unit, or receive from a cellular communication network the associations of the user equipments of the group with the at least one positioning reference unit.

According to an eighth aspect of the present disclosure, there is provided a non-transitory computer readable medium having stored thereon a set of computer readable instructions that, when executed by at least one processor, cause an apparatus to at least store, in a first user equipment, information defining a group of user equipments, the first user equipment being comprised in the group, and associate at least one positioning reference unit with the user equipments of the group such that each user equipment of the group is associated with at least one positioning reference unit, or receive from a cellular communication network the associations of the user equipments of the group with the at least one positioning reference unit.

According to a ninth aspect of the present disclosure, there is provided a non-transitory computer readable medium having stored thereon a set of computer readable instructions that, when executed by at least one processor, cause an apparatus to at least store, in a cellular core network node, information defining a group of user equipments, a first user equipment being comprised in the group, store information associating at least one positioning reference unit with the user equipments of the group such that each user equipment of the group is associated with at least one positioning reference unit, and determine a location of at least one user equipment in the group based on information concerning at least one of the positioning reference units associated with the user equipments in the group.

### BRIEF DESCRIPTION OF THE DRAWINGS

FIG. 1 illustrates an example system in accordance with at least some example embodiments of the present invention;

FIG. 2 illustrates an example system in accordance with at least some example embodiments of the present invention;

FIG. 3 illustrates an example apparatus capable of supporting at least some example embodiments of the present invention;

FIG. 4 illustrates signalling in accordance with at least some example embodiments of the present invention, and

FIG. 5 is a flow graph of a method in accordance with at least some example embodiments of the present invention.

### EMBODIMENTS

Herein are disclosed positioning mechanisms to position a group of user equipments, UEs, by associating the UEs of the group with one or more positioning reference units, PRUs. The number of PRUs is lower than the number of UEs, wherefore UEs of the group share the PRUs and each UE does not have its own PRU. The group of UEs is geographically limited such that the location of even a single PRU characterizes the location of all the UEs in the group. The physical dimension, size, of the group may depend dynamically on the situation at hand. In other words, the UEs of the group are close to each other. Further, the UEs of the group may be allocated a time-multiplexed transmission schedule for positioning reference signals, such as uplink sounding reference signal and/or sidelink positioning reference signal, such that the UEs of the group transmit these signals one after another in a controlled manner and two UEs of the group do not transmit at the same time. These features of the disclosed method provide the benefit and technical effect that resources are used in an optimized manner, which is difficult using conventional positioning procedures, and the proposed local coordination by exploiting sidelink provides the additional benefit of offloading signalling overhead. In general, the number of UEs in the group may be larger than the number of positioning reference units associated with the UEs in the group.

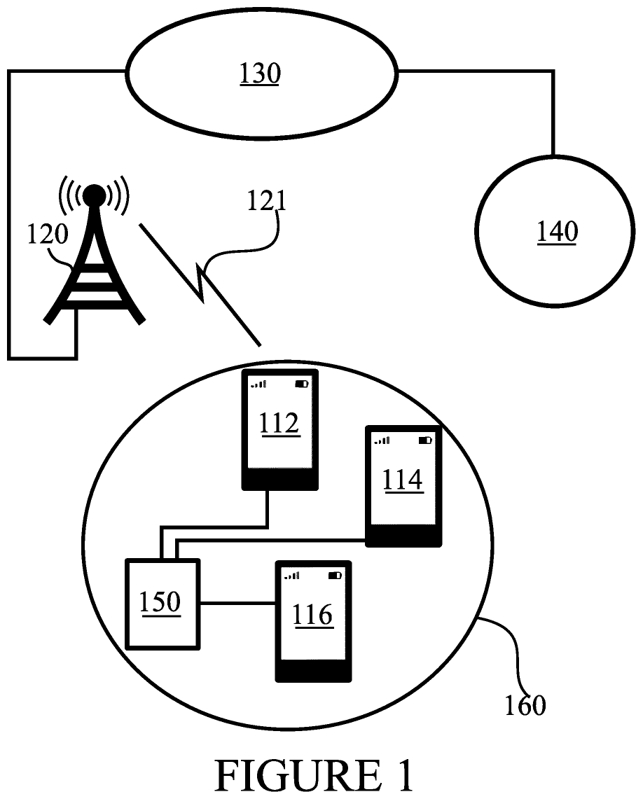

FIG. 1 illustrates an example system in accordance with at least some embodiments of the present invention. A cellular communication system comprises a radio-access network and a cellular core network 130. The radio-access network comprises at least one base station 120, it may comprise several hundred or even several thousand base stations. Base stations may be configured to control at least one cell each. Examples of cellular communication systems include fifth generation, 5G, systems, wideband code division multiple access, WCDMA, systems and long term evolution, LTE, systems.

User equipment, UE, 112 is communicatively coupled with base station 120 via wireless link 121, which conforms to a same communication standard as UE 112 and base station 120, to achieve interoperability. UE 112, 114, 116 may comprise a smartphone, a cellular phone, a tablet, laptop or desktop computer or, for example, a connected car communication module, as applicable. In general a UE may be a mobile device, such as a personal media device, or it may be fixedly installed, for example when the UE is a smart metering device installed to read out and provide to a back-end server information on water flow or electricity usage. An external network 140, such as the Internet, may be accessed via core NW 130.

In FIG. 1, a group 160 of UEs 112, 114, 116 is defined, such that the UEs of the group are close to each other. By being close to each other it may be meant, for example, that they are within sounding distance of a lead UE 112 and capable of communicating with the lead UE without using a base station, such as base station 120, or a relay device. By sounding distance it is meant a distance within which lead UE 112 can detect other UEs and determine, at least partially, a direction and distance to these other UEs. Lead UE 112 may be configured to define group 160 by selecting which UEs to include in the group, and which ones to exclude from it. In general, not all UEs 112, 114, 116 of group 160 need to have the same serving base station 120.

Positioning reference unit, PRU, 150 is a device with a known location. This may comprise that the PRU is fixed to a specific location which does not change, or, for example, that the PRU is furnished with an advanced positioning capability, such as multi-constellation satellite positioning or an interface to an airspace control system. A PRU may have at least a proper subset of the capabilities of a UE, in particular, a PRU may have positioning-related UE capabilities. For example, a PRU may be capable of transmitting to core NW 130 its own location. A PRU may be capable of transmitting and/or receiving electromagnetic pulses usable in estimating an distance of a UE from the PRU. These pulses may be comprised in sidelink, SL, communication between the PRU and UEs of group 160. By sidelink it is meant device-to-device, such as UE-to-UE, communication which does not traverse a base station device, wherein one device transmits electromagnetic energy which is received by a receiver comprised in the receiving device, in other words, the communication is direct without traversing any other node, such as base station or relay. PRUs may be configured to provide positioning measurements, such as reference signal time difference, RSTD, reference signal received power, RSRP, and/or receive-transmit, Rx-Tx, time differences, and to transmit uplink, UL, sounding reference signals, SRS, for positioning, depending on the embodiment. In practical terms, one example of a PRU is a device fixedly installed in a known location (with known {X, Y, Z} coordinates), such as a light post, conducting positioning measurements and estimating its location in the same way as nearby UEs conduct measurements and estimate their location. The outcome of the comparison of the PRU's estimated location versus the (known) true location is used at the nearby UEs to refine their own location estimates. In some cases a PRU may be a UE with a dependable positioning capability. The PRU is not, however, necessarily one of the UEs in the group of UEs, although it might be if the PRU is a UE.

In essence, lead UE 112 defines group 160 by selecting the UEs 112, 114, 116 to include in it, and associates a PRU 150 with each one of the UEs in the group. Whereas FIG. 1 illustrates the case where all the UEs in the group are associated with the same PRU 150, the lead UE 112 may alternatively associate some UEs of the group with different PRUs. In general, however, the number of PRUs is smaller than the number of UEs in the group, such that the UEs of the group are not all associated with different PRUs. The associated PRU will be used for UL and/or SL positioning. In general, group 160 of target UEs 112, 114, 116 in physical proximity to each other can benefit from the same PRU for improving their positioning accuracy, since the UEs, being near to each other, are expected to share similar radio conditions. In addition, the group 160 of UEs may benefit from multiplexed positioning reference signals, such as UL SRS and/or SL PRS transmissions for UL and SL positioning purposes, respectively, which provides the benefit of enhanced positioning latency. In some embodiments, group 160 is split into subgroups where each subgroup is associated with a distinct PRU. The subgroups may be defined based on similarities in UE movement state within the overall group 160, for example. Once the associations are done, lead UE 112 may inform the member UEs of the associations, either of all of them, or just each UE of its specific associated PRU. Lead UE 112 may perform this informing, for example, using SL communication within the group. In one embodiment, lead UE 112 sends a SL broadcast message to associated group member UEs about the PRU associations, to enable the group member UEs to perform SL positioning each with its associated PRU.

Alternatively to the lead UE 112 associating the PRUs with UEs of the group, a core NW 130 node such as the location management function, LMF, may perform this associating, once lead UE 112 provides information defining the group to the core NW node. The information provided to the core NW node may comprise relative location or relative movement state information of the UEs, for example, determined by lead UE 112 by electromagnetic sounding. The core NW node may then provide the associations of PRUs to UEs to the lead UE, which may inform each UE in the group of either all the associations, or just the association relating to the UE in question. Communication between lead UE 112 and the core NW node, such as LMF, concerning the associating of UEs with PRUs may take place using a long term evolution positioning protocol, LPP, signalling, for example. This applies regardless of whether it is lead UE 112 or the LMF, for example, which performs the associating. Alternatively to informing only lead UE 112, the LMF may send LPP messages to the associated group member UEs about the PRU associations individually. Additionally or alternatively, LMF and one or more base stations may use NRPPa and radio resource control, RRC, signaling to broadcast to group 160 of UEs in the downlink direction the association (mapping) between PRU identities and group member UE identities. Alternatively, LMF and a base station may transmit the information regarding the association of group members to PRU IDs first to lead UE 112, which may then broadcast this information over SL to the group 160 member UEs.

Once the associating of UEs in group 160 to PRUs is complete and the UEs are aware of which PRU they have been associated with, the UEs may perform SL positioning with their associated PRU.

Lead UE 112 may define the group by first selecting an effective size of the group physical dimension, that is, length, or radius, for the group, and then choosing UEs within this selected length of itself to be included in the group. The effective physical dimension may be selected based on at least one of the following: a radio coherency level, a positioning integrity and a quality of service requirement. Typically, the richer the scattering radio propagation environment, the smaller the coherent radio space and thus the smaller the group effective size. Radio coherency depends on radio characteristics of the environment, and mobility of lead UE 112. In general terms, the effective physical dimension may be selected based on mobility conditions of the UEs. In case their mobility is high, then only UEs moving in a similar manner to lead UE 112 can be included in the group, since otherwise the group would scatter and render it useless for enhancing positioning. An example of such co-moving UEs are ones which are on a same moving vehicle as lead UE 112. Typically, the larger the effective size of the group, the smaller the precision of the obtained location estimate (that is, the larger the variance of the location estimate). As a result, when a quality of service requirement is used to select the group, lead UE 112 obtains integrity requirements and translates the integrity requirements into the permissible effective size for the group that satisfies such requirements. In other words, if required positioning accuracy is high, the group must be smaller in size to meet the quality requirement. A group size determination may be triggered by lead UE 112 itself, another UE in the group, or a core NW 130 node, such as a LMF, for example. If a movement state of lead UE 112, or another UE, changes, it is likely the group 160 needs to be re-defined to avoid a degradation of positioning accuracy.

Once the group 160 is defined, lead UE 112 may generate a time-multiplexed transmission schedule for positioning reference signals for the UEs 112, 114, 116 in the group, such as, for example, a time-multiplexed uplink, UL, sounding reference signal, SRS and/or sidelink, SL, positioning reference signal, PRS transmission schedule. Lead UE 112 may inform the network, and group 160 member UEs, of the defined time-multiplexed transmission schedule. By such a time-multiplexed transmission schedule it is meant a transmission schedule wherein each UE of the group has a transmission slot for transmitting its positioning reference signals, such as UL SRS and/or SL PRS, and the transmission slots of the UEs of the group do not overlap, such that collisions are avoided using the time-multiplexed transmission schedule. For example, according to the time-multiplexed transmission schedule, member UEs may transmit UL SRS in a round-robin fashion, contiguously over time domain. In one embodiment, the set of UEs multiplexing said SRS configuration corresponds to the set of UEs that shares the same PRU within group 160. In another embodiment, the set of UEs multiplexing SRS configuration share different PRUs.

Alternatively to the lead UE 112 determining this time-multiplexed transmission schedule, a base station, such as base station 120 serving lead UE 112, may determine the schedule, and provide it to the UEs of the group either individually, by groupcast or by providing it to lead UE 112, lead UE 112 then disseminating the time-multiplexed transmission schedule to other UEs of the group using, for example, sidelink communication.

Once the time-multiplexed transmission schedule has been defined and provided to group 160 member UEs, LMF, or another core NW 130 node, may configure the same set of base station transmission/reception points, TRPs, to receive the configured UL SRS transmissions. These base stations may be gNB nodes in a fifth generation radio-access network, for example.

The mechanisms disclosed here clearly improve latency and resource efficiency for UL positioning, compared to prior positioning methods in multiple ways. Firstly, in prior systems, in case different UEs are served by different base stations or if some of them are outside network coverage, the SRS transmission schedule can be only signaled by multiple base stations serving or reaching the different UEs, in a one-to-one fashion, yielding a larger amount of signaling and associated latency. Secondly, multiple base stations cannot easily multiplex different SRS configurations belonging to different UEs in a desired manner, since there is in prior systems no positioning mechanism to enable such coordination across plural base stations, such as gNBs, for SRS configuration. Thirdly, even served and configured by the same base station, the prior mechanisms require one-to-one signalling between the network and the group of UEs to transmit assistance data, thus yielding more signalling and higher resource consumption than the case where lead UE 112 is used to disseminate the association information and time-multiplexed transmission schedules, for example via the sidelink.

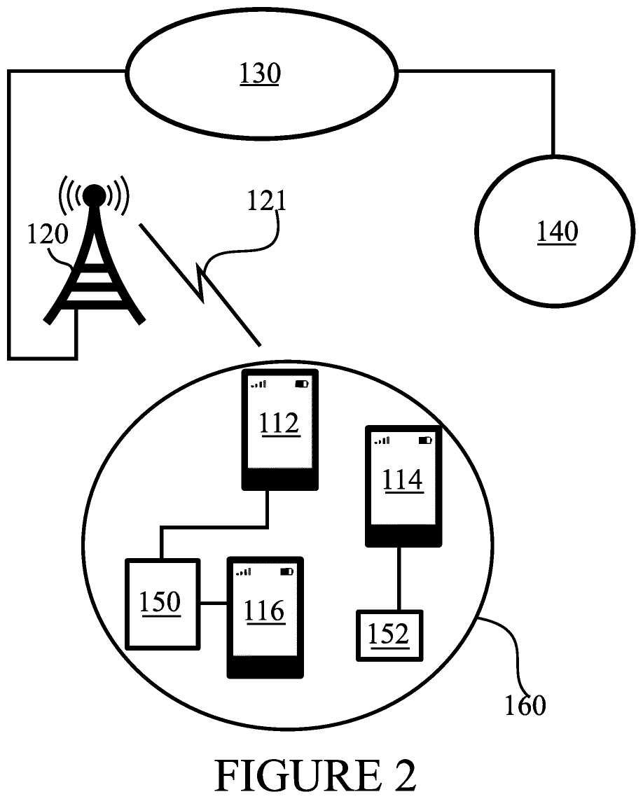

FIG. 2 illustrates an example system in accordance with at least some embodiments of the present invention. Like numbering denotes like elements as in FIG. 1. The situation in FIG. 2 differs from that in FIG. 1 in that UE 114 of group 160 is not associated with the same PRU 150 as the other two UEs 112, 114. Rather, UE 114 is associated with PRU 152, which need not be of a same type as PRU 150. This association may be a result, for example, of a determination in lead UE 112 or a core NW node, whichever is tasked with performing the associating, that of the UEs in group 160 UE 114 is closer to PRU 152 than PRU 150, while UEs 112 and 116 are closer to PRU 150. In general, the present disclosure is by no means limited to the numerical example that the group should comprise specifically three UEs. Also, despite FIGS. 1 and 2 illustrating PRUs 150, 152 as within a circle denoting group 160, in principle the PRUS need not be within a geographic limit defined for UEs in the group, rather, they may well be slightly outside the limit. It is the UEs which are comprised in the group as defined in information defining a list of UE identities comprised in the group. PRU(s) are not comprised in this list, except in the particular case where one of the UEs of the group happens to be one of the associated at least one PRU.

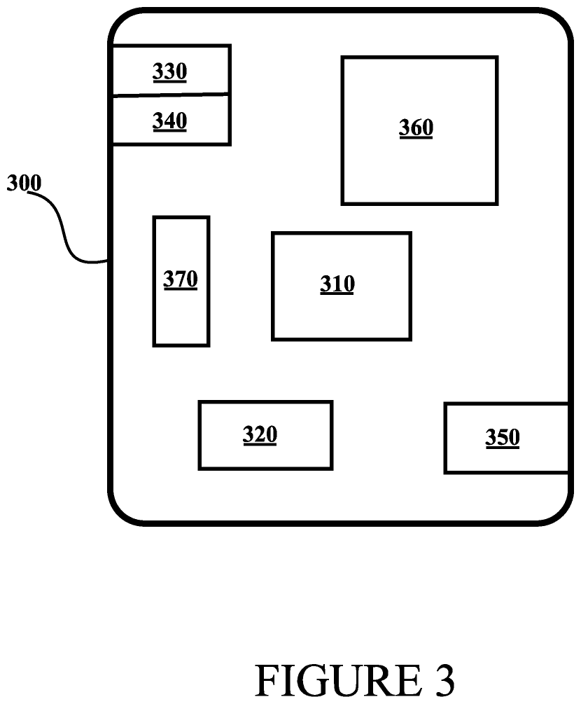

FIG. 3 illustrates an example apparatus capable of supporting at least some embodiments of the present invention. Illustrated is device 300, which may comprise, for example, a mobile communication device such as UE 112 of FIG. 1 or FIG. 2 or, in applicable parts, a base station or device running a core network node, such as LMF. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor unit. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as storing, associating, receiving, informing, generating, selecting, determining and controlling, for example. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory (ies) that work together to cause an apparatus, such as a user equipment or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the example embodiment various ways of interconnecting at least two of the aforementioned devices may be selected without departing from the scope of the present invention.

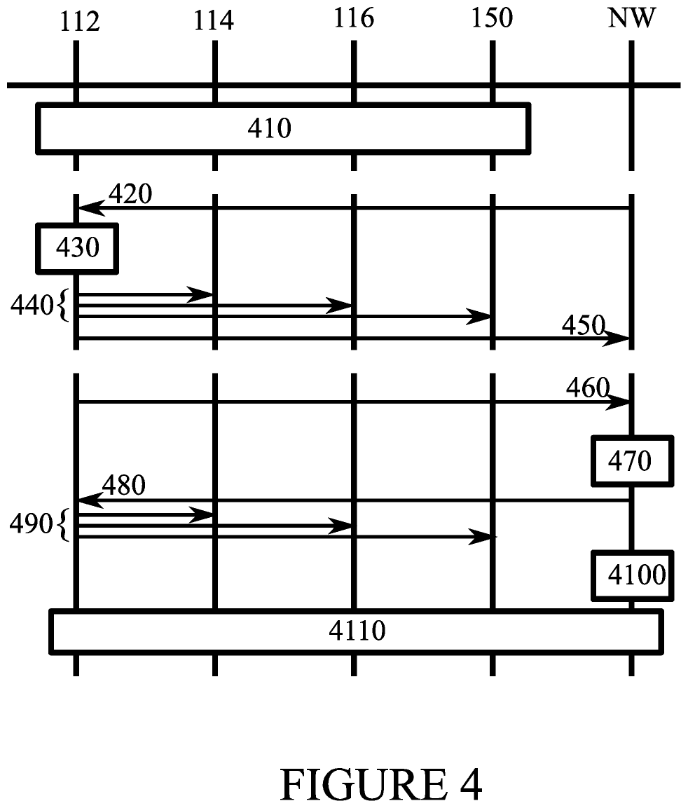

FIG. 4 illustrates signalling in accordance with at least some example embodiments of the present invention. On the vertical axes are disposed, from the left, lead UE 112, UE 114, UE 116 and PRU 150 of FIG. 1, and on the right, the network NW which comprises a radio-access NW and a core NW. Time advances from the top toward the bottom. The figure illustrates two alternative processes, a first alternative comprising phases 410-450 and a second alternative comprising phase 410 and phases 460-4100. Phase 4110 is a common endpoint of both alternatives.

In initial phase 410, SL measurements are conducted. These measurements may comprise ranging and/or positioning, and lead to lead UE 112 having knowledge of UEs nearby.

Phase 420 comprises the NW providing UL SRS/SL PRS pre-configurations to lead UE 112. In phase 430, lead UE 112 determines the positioning group (group 160 in FIGS. 1 and 2), for example based on first selecting a geographic extent for the group, and the lead UE associates to each UE in the group a PRU, as described herein above. Lead UE 112 may also define time-multiplexed transmission schedules for positioning reference signals, such as UL SRS and/or SL PRS for the UEs which are members of the group.

In phases 440, lead UE 112 informs the group members and, optionally, associated PRU(s) of the associations between UEs and PRUs and, where the lead UE 112 defines the time-multiplexed transmission schedules for the positioning reference signals for the members of the group, also these are informed to the member UEs and, optionally, associated PRUs. For example, the informing of phase 440 may take place over SL signalling. In phase 450, lead UE 112 informs the network, such as an LMF, of the associations between UEs and PRUs and, where the lead UE 112 defined the time-multiplexed transmission schedules for positioning reference signals for the members of the group, also these are informed to the NW.

In the second alternative example embodiment, the process flows from phase 410 to phase 460, where lead UE 112 informs the NW of SL measurements of phase 410, and PRUs which might be considered. Responsively, phase 470, the NW, for example an LMF, defines the group of UEs and associates a PRU identity to each UE identity comprised in the group. Likewise, the NW, for example the LMF, determines the time-multiplexed transmission schedules for positioning reference signals, such as the UL SRS and/or SL PRS, for the members of the group.

In phase 480 the NW informs lead UE 112 of the associations and transmission schedules determined in phase 470, and in phases 490 lead UE 112 distributes this information in the group, for example over SL signalling. Also the PRU(s) may be informed.

Finally, phase 4110, uplink, downlink, or sidelink positioning may be used, leveraging information from the PRUs, using the associations of UEs with PRUs and, where present, also the time-multiplexed transmission schedules for the positioning reference signals, such as the UL SRS and/or SL PRS for the members of the group.

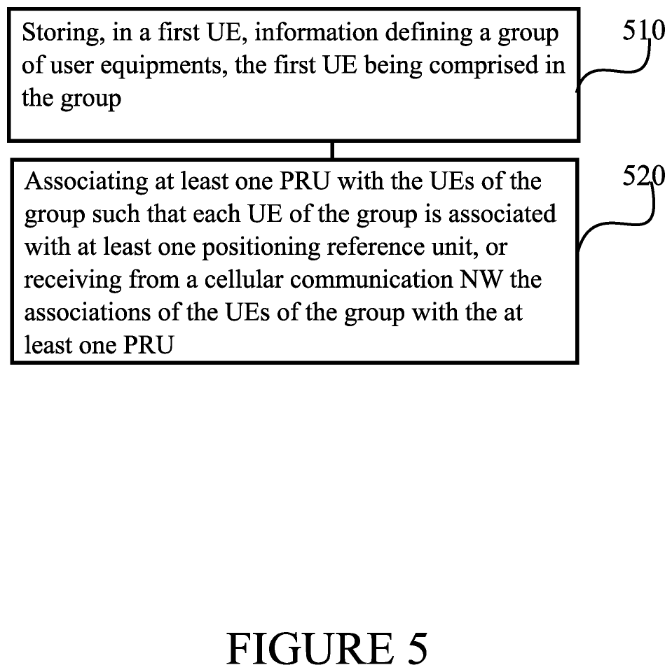

FIG. 5 is a flow graph of a method in accordance with at least some example embodiments of the present invention. The phases of the illustrated method may be performed in lead UE 112, or in a control device configured to control the functioning thereof, when installed therein.

Phase 510 comprises storing, in a first user equipment, information defining a group of user equipments, the first user equipment being comprised in the group. Phase 520 comprises associating at least one positioning reference unit with the user equipments of the group such that each user equipment of the group is associated with at least one positioning reference unit, or receive from a cellular communication network the associations of the user equipments of the group with the at least one positioning reference unit. The number of user equipments in the group may be larger than the number of positioning reference units associated with the user equipments in the group. Each user equipment of the group being associated with at least one positioning reference unit may comprise that each user equipment of the group is associated with one and only one positioning reference unit.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one example embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in wireless positioning.

### ACRONYMS LIST

LMF location management function
NRPPa new radio positioning protocol A
NW network
PRS positioning reference signal
PRU positioning reference unit
RRC radio resource control
SL sidelink
SRS sounding reference signal
TRP transmission/reception point
UE user equipment

### REFERENCE SIGNS LIST

| | |
|---|---|
| 112, 114, 116 | user equipments, UEs |
| 120 | base station |
| 121 | radio link |
| 130 | core network |
| 140 | external network |
| 150, 152 | positioning reference units, PRUs |
| 300-360 | structure of the device of FIG. 3 |
| 410-4110 | phases of the process(es) of FIG. 4 |
| 510-520 | phases of the method of FIG. 5 |

1-15. (canceled)

16. An apparatus comprising at least one processing core, and at least one memory including computer program code that, when executed by the at least one processing core, causes the apparatus at least to:
store information defining a group of user equipments, the apparatus being comprised in the group; and
associate the apparatus with at least one positioning reference unit or receive from a cellular communication network association of the apparatus with the at least one positioning reference unit.

17. The apparatus according to claim 16, wherein the computer program code, when executed by the at least one processing core, further causes the apparatus to inform each user equipment in the group of an identity of a positioning reference unit associated with the apparatus.

18. The apparatus according to claim 16, wherein the computer program code, when executed by the at least one processing core, further causes the apparatus to:
generate a time-multiplexed uplink sounding reference signal and/or sidelink positioning reference signal transmission schedule for the user equipments in the group, or
receive the time-multiplexed uplink sounding reference signal and/or sidelink positioning reference signal transmission schedule for the user equipments in the group from the cellular communication network and/or from another user equipment from a second network; and
inform each user equipment in the group of its specific uplink sounding reference signal and/or sidelink positioning reference signal transmission schedule from among the generated or received time-multiplexed transmission schedule.

19. The apparatus according to claim 16, wherein the user equipments of the group are in physical proximity to each other, such that the apparatus is enabled to communicate with all other user equipments of the group directly without recourse to a relay or base station device.

20. The apparatus according to claim 16, wherein the computer program code, when executed by the at least one processing core, further causes the apparatus to select user equipments to include in the group based on physical dimensions of the group, wherein all the user equipments in the group are associated with the same positioning reference unit.

21. The apparatus according to claim 16, wherein the computer program code, when executed by the at least one processing core, further causes the apparatus to select the physical dimensions of the group based on at least one of the following: a radio coherency level with respect to the physical dimensions of the group or effective size of the group, a positioning integrity or a quality of service requirement.

22. An apparatus comprising at least one processing core, and at least one memory including computer program code that, when executed by the at least one processing core, causes the apparatus at least to:
store information defining a group of user equipments, a first user equipment being comprised in the group;
store information associating at least one positioning reference unit with the user equipments of the group such that each user equipment of the group is associated with at least one positioning reference unit; and
determine a location of at least one user equipment in the group based on information concerning at least one of the positioning reference units associated with the user equipments in the group.

23. The apparatus according to claim 22, wherein the computer program code, when executed by the at least one processing core, further causes the apparatus to:
generate, and provide to at least one user equipment of the group, the information associating at least one positioning reference unit with the user equipments of the group, or
receive the information associating at least one positioning reference unit with the user equipments of the group from the first user equipment.

24. An apparatus comprising at least one processing core, and at least one memory including computer program code that, when executed by the at least one processing core, causes the apparatus at least to:
control at least one cellular cell;
receive a list of user equipments comprised in a group, not all of the user equipments in the group being in the at least one cellular cell controlled by the apparatus;
generate, and provide to at least one user equipment of the group, a time-multiplexed uplink sounding reference signal and/or sidelink positioning reference signal transmission schedule for the user equipments in the group, or
receive the time-multiplexed uplink sounding reference signal and/or sidelink positioning reference signal transmission schedule for the user equipments in the group from a first user equipment from among the user equipments in the group.
